(19) United States
(12) Patent Application Publication
(10) Pub. No.: US 2018/0144097 A1
(43) Pub. Date: May 24, 2018

(54) Method and System for Tag-Based Task Creation, Monitoring and Escalation

(71) Applicant: Smartpager Systems Inc., Victoria (CA)

(72) Inventor: Russell Benjamin Moore, Victoria (CA)

(21) Appl. No.: 15/816,267

(22) Filed: Nov. 17, 2017

Related U.S. Application Data
(60) Provisional application No. 62/424,186, filed on Nov. 18, 2016.

(51) Int. Cl. G06F 19/00; G06K 7/10; G06K 7/14

(52) U.S. Cl. CPC G06F 19/324; G06K 7/1417; G06K 7/1413; G06K 7/10366

(57) ABSTRACT

Coded tags are placed at various locations in a building or group of buildings. Each tag represents one or more tasks to be performed in relation to its context. When a tag is scanned by a user device, either a task is automatically generated or the user is given a list of tasks from which a selection is made, following which the task is automatically generated. Tasks are automatically routed to the users responsible for performing the tasks. Time to perform the tasks is monitored and can be analyzed across the building(s). Alerts are sent to designated individuals in the case of non-performance of the tasks in the allotted time, or when there is a general trend of slow performance of the tasks. The system enables an increase in efficiency with which the tasks in the building(s) are assigned and performed.

### CROSS-REFERENCE TO RELATED APPLICATIONS

This application claims the benefit of U.S. provisional patent application Ser. No. 62/424,186, filed on Nov. 18, 2016, which is incorporated by reference herein in its entirety.

### TECHNICAL FIELD

This application relates to a method and system for creating tasks. More particularly, this application relates to a framework for structuring, sending, monitoring, escalating and analyzing tasks that are created automatically in response to tag detection.

### BACKGROUND

Nurses in hospitals often need to request tasks to be performed by other hospital personnel. Such tasks may be to request replenishment of supplies, clean a spillage or fulfill a patient request. Determining who to ask and how to ask can be time consuming, which can be a problem especially when nurses are already under considerable time pressure to assist the patients. Even more problematic is how to deal with requested tasks that are not completed. Furthermore, management may not have a clear picture of the problems.

U.S. Pat. No. 7,978,082 to Braunstein discloses Radio Frequency Identification (RFID) based personnel tracking, including receiving data from a first scan of an RFID tag upon initiation of a task, receiving data from a second scan of the RFID tag upon termination of the task, and uploading the data to a computer.

U.S. Pat. No. 8,240,550 to Steusloff discloses a system for managing administration of medical care. The system includes a patient record system that contains electronic records for patients in a hospital. The electronic records may include scheduling information for medicine administration to the patient. A display terminal can be connected to the patient record system and be configured to read an RFID tag on the patient. The display terminal can then identify the patient and display the patient's medicine schedule.

U.S. Pat. No. 8,308,056 to Marco discloses obtaining location associated information through the use of a telecommunications device and a two-dimensional code in which the information is stored. The information obtained relates to the geographical position of the two-dimensional code as well as to additional data such as a description thereof, a contact telephone number or its opening hours.

U.S. Patent Application Publication 2004/0220822 to Talarico provides an apparatus for diarizing the performance of janitorial services during a patrol. The apparatus can be a personal digital assistant (PDA) that includes a bar-code scanner. The scanner is used to scan bar codes that are applied at various locations throughout a facility. The bar codes identify individual locations in the facility that are to be cleaned as part of a janitorial patrol. The PDA is further operable to allow the janitor to add electronic comments about cleaning tasks that are performed at the locations.

U.S. Patent Application Publication 2008/0164998 to Scherpbier discloses a workflow management system integrated with a healthcare information system and uses location tracking of patients, providers and resources in addition to relevant patient data in managing tasks of clinicians associated with care of a patient. A tracking processor monitors healthcare worker, patient and equipment location, to provide device and personnel location data by detection of wirelessly communicating tag devices. A display associates a work task, comprising providing a treatment related service to a patient, for performance by a healthcare worker, with a current location of a patient and equipment to be used in providing the treatment related service.

This background information is provided to reveal information believed by the applicant to be of possible relevance to the present invention. No admission is necessarily intended, nor should be construed, that any of the preceding information constitutes prior art against the present invention.

### SUMMARY OF INVENTION

The present invention is directed to a method and system for automatically creating tasks, in that tasks are predefined by a template and schema, and then specifically created or triggered by a user scanning a tag with a code that specifies the task. The task may be simply a message, which, in particular is a structured message defined by the template. The task may be one of several tasks that are related to the code in the tag. In other cases, the task may be defined by one or more parameters that are selected by the user, which appear on a user's smartphone when the tag is scanned.

As such, various parameters are required to be defined for the tasks before they can be sent. Furthermore, tasks may be redirected according to escalation policy rules, which may in some cases be time-dependent rules. Finally, other actions may be taken depending on a statistical analysis of similar types of tasks over a period of time.

The invention may be used in healthcare environments, for example. A benefit of this invention is to decrease the amount of time taken in the assignment and completion of tasks in a healthcare setting, through the use of mobile devices and coded tags that use QR codes, barcodes and/or RFID codes.

Disclosed herein is a method of creating a task comprising the steps of scanning, with a user device, a tag that carries a code; displaying, on the user device, a plurality of tasks that are related to the code; receiving, by the user device, a selection of one of the tasks; and sending a message to a recipient device, wherein the message notifies the recipient device of the selected task.

Also disclosed herein is a system for creating a task comprising a tag with a code that relates to a plurality of tasks; a user device; and a recipient device; wherein the user device is configured to scan the code; display the plurality of tasks; receive a selection of one of the tasks; and send, to the recipient device, a message that notifies the recipient device of the selected task.

Further disclosed herein are computer readable media storing computer readable instructions, which, when executed by one or more processors, cause a user device to scan a tag with a code that relates to a plurality of tasks; display the plurality of tasks; receive a selection of one of the tasks; and send, to a recipient device, a message that notifies the recipient device of the selected task.

### BRIEF DESCRIPTION OF DRAWINGS

The following drawings illustrate embodiments of the invention and should not be construed as restricting the scope of the invention in any way.

FIG. 1 is a schematic diagram showing a structured task creation and management system according to an embodiment of the present invention.

FIG. 2 is a schematic screen shot of an acknowledgment provided to a user who has just scanned a tag to create a task, according to an embodiment of the present invention.

FIG. 3 is a schematic screen shot of an option list provided to a user who has just scanned a tag to create a task, according to an embodiment of the present invention.

FIG. 4 is a screen shot of a template for defining a task associated with a tag according to an embodiment of the present invention.

FIG. 5 is a schematic screen shot of a list of tasks created by a user and their statuses, according to an embodiment of the present invention.

FIG. 6 is a schematic screen shot of a list of tasks assigned to a particular user, according to an embodiment of the present invention.

FIG. 7 is a schematic screen shot of a dashboard for displaying statistics of all tasks, according to an embodiment of the present invention.

FIG. 8 is a flowchart of a method to create and monitor a task, according to an embodiment of the present invention.

FIG. 9 is a flowchart of a method to provide a user with options relating to a task to be created, according to an embodiment of the present invention.

FIG. 10 is a flowchart for escalating an uncompleted task, according to an embodiment of the present invention.

FIG. 11 is a flowchart for detecting a trend, according to an embodiment of the present invention.

### DESCRIPTION

### A. Glossary

The term “firmware” includes, but is not limited to, program code and data used to control and manage the interactions between the various modules of the system.

The term “hardware” includes, but is not limited to, the physical housing for a computer as well as the display screen, connectors, wiring, circuit boards having processor and memory units, power supply, and other electrical components.

The term “module” can refer to any component in this invention and to any or all of the features of the invention without limitation. A module may be a software, firmware or hardware module, and may be located in a user device or a server.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “software” includes, but is not limited to, program code that performs the computations necessary for defining tasks, creating tasks, processing user input, formulating output, routing messages and tasks, the reporting of task related data, displaying information, and the performance of data-related calculations.

The term “structured message” means a message that has predefined fields that form part of the content of the message, where the number and type of the fields depend on the type of the message. The fields are required to be completed before the message can be sent. In contrast to a traditional or more casual message such as an email, which has a free text component for the message content, a structured message forces some of the message content to be included in the predefined fields. A structured message may be considered to be a form-based message. A task created by the system of this invention may be disseminated as a structured message.

The term “system” when used herein refers to a tag-based task system, which is a system for structuring, sending, monitoring, escalating and analyzing tasks that are created automatically in response to tag detection, the system being the subject of the present invention. The system is able to manage the definition of recipients, the parameters for the tasks, the sending and receiving of messages relating to the tasks, and the actions to take based on the performance of particular tasks or on task analytics.

The term “user” refers to a person who uses the system or interacts with it via a user device. There may be different types of user, such as a user who sends creates tasks, a recipient user who receives messages relating to tasks and accepts them, an administrator who sets up groups of users, or a manager, supervisor or other user who defines task-based rules, parameters and actions for example. A user is typically an end user, which generally refers to a person other than an IT (information technology) administrator. Users may have different roles within the organization that uses the system. Users may also be outside the organization, such as patients, relatives and third party lab technicians who may not be part of a hospital that uses the system.

### B. System

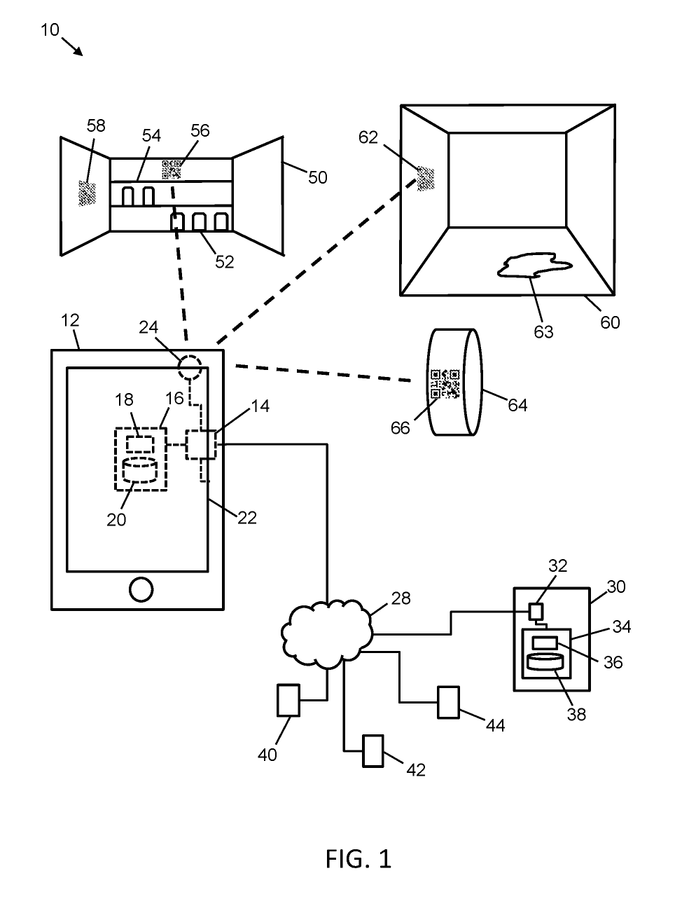

Referring to FIG. 1, there is shown an exemplary embodiment of a tag-based task system 10 in accordance with the processor-implemented invention described herein. The system 10 includes or interacts with a user computing device 12, which is a smartphone. In other embodiments, device 12 may be a tablet or a tag scanner for example, or any other electronic device that provides the necessary equivalent functionality to fulfill the requirements of the system. The user device 12 includes one or more processors 14 which are operably connected to computer readable memory 16 included in the device. The system 10 includes computer readable instructions 18 (e.g. an application) stored in the memory 16 and computer readable data 20, also stored in the memory. The memory 16 may be divided into one or more constituent memories, of the same or different types. The user device 12 includes a display screen 22, operably connected to the processor(s) 14. The display screen 22 may be a traditional screen, a touch screen, a projector, an electronic ink display or any other technological device for displaying information. The user device 12 also includes a camera 24, which is capable of photographing QR (quick response) codes, bar codes or other two-dimensional codes. In other embodiments, the camera 24 may be replaced or supplemented with another kind of detector, such as an RFID (radio frequency identification) tag detector or NFC (near-field communications) reader.

The user device 12 is connected to or into the system 10 via a network 28, which may, for example, be the internet, a telecommunications network, a local area network, a bespoke network or any combination of the foregoing. Communications paths in the network 28 may include any type of point-to-point or broadcast system or systems. Other users may have further user devices 40, 42, 44 with functionally equivalent components to those of device 12, which may also be part of, or connected to, the system 10. User devices 40, 42, 44 are portable computing terminals, which may be smartphones.

The system 10 also includes a server 30, which has one or more processors 32 operably connected to a computer readable memory 34, which stores computer readable instructions 36 and computer readable data 38. Data 38 may be stored in a relational database, for example or other type of database. Some or all of the computer readable instructions 18, 36 and computer readable data 20, 38 provide the functionality of the system 10 when executed or read by the processors 14, 32. Computer readable instructions may be broken down into blocks of code or modules.

The user of the device 12 may work in a hospital environment, for example, where there is a cabinet 50 with various supplies 52. In this example, the syringe shelf 54 of the cabinet 50 is empty. At the back of the shelf 54 there is a QR tag 56 (i.e. a tag containing a QR code) affixed to the inner wall of the cabinet 50. The tag 56 has coded information that at least identifies the tag, and may contain further information relating to its location, context and/or what is intended by the placement of the tag. If the further information is not directly encoded in the tag, it can be retrieved from the database 38 in the server 30 using a lookup operation. In other words, all of the contextual information related to the tag does not need to reside on the tag. The tag may have some or all of the contextual information. The remainder of the contextual information is indexed in the database 38 on the server 30. Some or all of the contextual information that is on the tag can be duplicated in the database.

The user can scan the QR tag 56 with the user device 12, and, as a result, software running on the device identifies the tag and automatically creates a task for the on-call supply clerk to replenish the syringes. The actual person the task is sent to will be obtained from the employee schedule. Likewise, there may be other QR tags affixed to the other shelves that, when scanned, automatically create tasks for the replenishment of the usual contents of those shelves. Instead of an individual QR tag for each shelf or each product, there may be a single QR tag 58 for the whole cabinet 50. In this case, when the single tag 58 is scanned, the user device 12 automatically presents, via a user interface such as a touchscreen 22, the user with a list of supplies that are normally kept in the cabinet, from which the user selects the supply that has been depleted.

In the hospital there are various rooms 60, each with a QR tag 62 affixed to one of its walls, either inside or outside the room, or on a door to the room. In this example, there is a spillage 63 on the floor of the room 60. The user can use the user device 12 to scan the QR tag 62 on the wall of the room 60 to automatically create a task for a janitor to come and clean the spillage 63. As there are likely to be other tasks that arise in connection to the room 60, the user is presented with an option list from which to select the task or tasks that need to be done.

Patients in the hospital wear wristbands 64 that carry a QR tag 66 that identifies the patient. A nurse can scan the tag 66 with user device 12 in order to initiate tasks related to the patient, such as bringing the patient a cup of water.

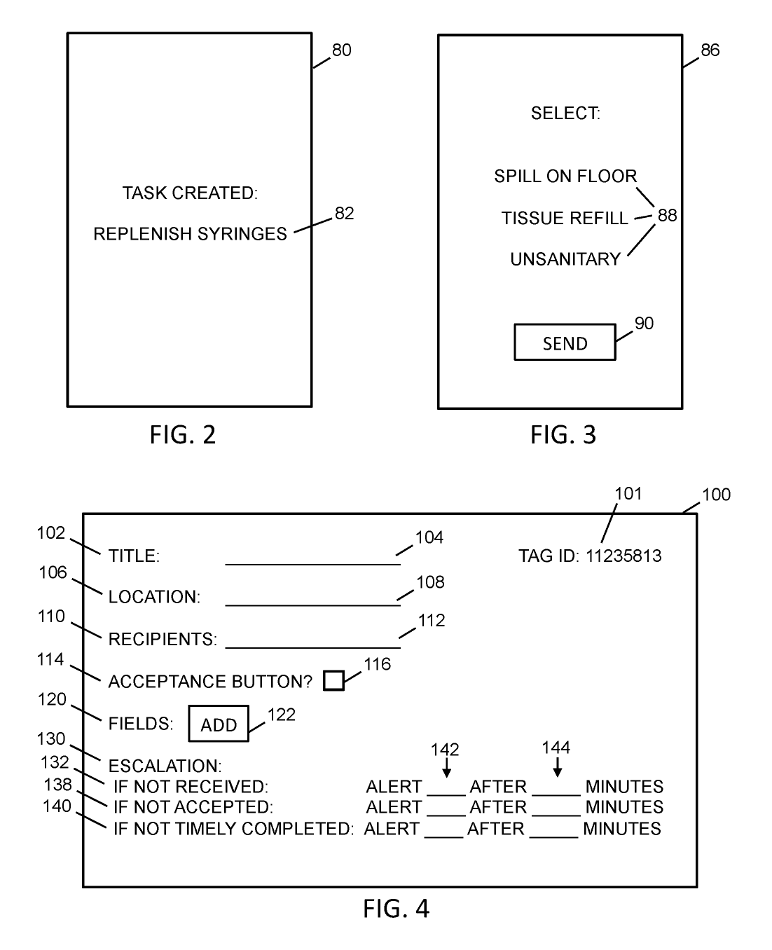

Referring to FIG. 2, an example screenshot 80 of the user device 12 is shown after the user device has scanned tag 56 in cabinet 50, the tag indicating that the syringes need replenishing. The task to replenish the syringes is automatically created and the screen 22 of the user device 12 shows an acknowledgment 82 of the creation of the task. In this case, the task is automatically created and routed just by placing the user device 12, when in scanning mode, in proximity of the tag 56 to scan it. Once a job/task has been created, it is routed over the network 28 to another user, either on a smartphone, computer, web browser, or other mobile device, e.g. 40, 42, 44.

Referring to FIG. 3, an example screenshot 86 of a user device 12 is shown after the device has been used to scan a tag such as tag 62 in room 60. For this tag 62, as there is some information required or choices to be made by the user before a task can be submitted, the device 12 presents the user with options 88 representing situations that the tag relates to. The options in this example include: spill on the floor; toilet tissue replenishment needed; and room is unsanitary. The user is invited to select one of the options 88 or, in some embodiments, more than one may be selected. When the user has made a selection from the options 88, the user can then tap the Send button 90 to submit the task. As above, once a job/task is created, it is routed over the network 28 to another user or users.

Referring to FIG. 4 a template 100 is shown for setting up the task(s) that are to be automatically created upon a particular tag 101 being scanned. The template 100 can be configured with specific task details to result in a schema for a tag. Each template has a number of properties associated with it, including, but not limited to: Title 102, to be defined at space 104 by a manager; Location 106, to be defined at space 108; Recipients 110, to be entered at space 112; Acceptance Button 114, to be shown on recipient device if check box 116 is checked; Fields 120, to be added optionally by tapping on button 122; and Escalation Policy 130. The escalation policy 130 has multiple parts, including what to do if the task that is created is not received 132; what to do if the task is received but not accepted 138 (or declined); and what to do if the task is not timely completed 140. Each of these can be configured by completing the blanks for whom to alert 142 and when they should be alerted 144, which is defined here as a number of minutes after the task has been created.

Recipients can be prepopulated in the schema as either individuals, broadcast groups, or from on-call schedules. One of the recipients may be another machine end point. Acceptance buttons (Accept/Decline) may be automatically included in the task requests sent to the recipients and so in some embodiments are not specified in the template 100. Fields may include any number of date, time, choice, numeric field, text field, and images. For example, one of the fields may be a selection field that presents the choices of task given to the user in the options 88 of FIG. 3. Each option may have its own escalation policy. In other cases, the fields may represent parameters for the task, for which parameter values must be defined by the user requesting the task. For example, when a syringe replenishment is requested, the user may be required to input or select the type of syringe that needs replenishing.

When a user receives a task request, the task is presented using the fields and information prepopulated in the fields in the schema. Note that, instead of the information pertaining to the task being on the server, indexed by a unique identifier that is coded in the tag itself, it may be encoded in the tag.

When a task is accepted by the recipient machine or person who is going to perform the task, the sender of the task is notified that the task has been accepted. Likewise, when a task is completed by the recipient machine or person, the sender of the task is also notified. Referring to FIG. 5, a screenshot of the requesting user's device 12 is shown, in which the list of tasks created 150 by the user is shown. The first task 152 (replace syringes) is showing as not yet accepted; the second task 154 (clean spillage) is showing as accepted; and the third task 156 (give patient water) is showing as completed. Tasks may be displayed and tracked in a chronological order with a countdown timer on them to show how much time is left to complete the outstanding tasks.

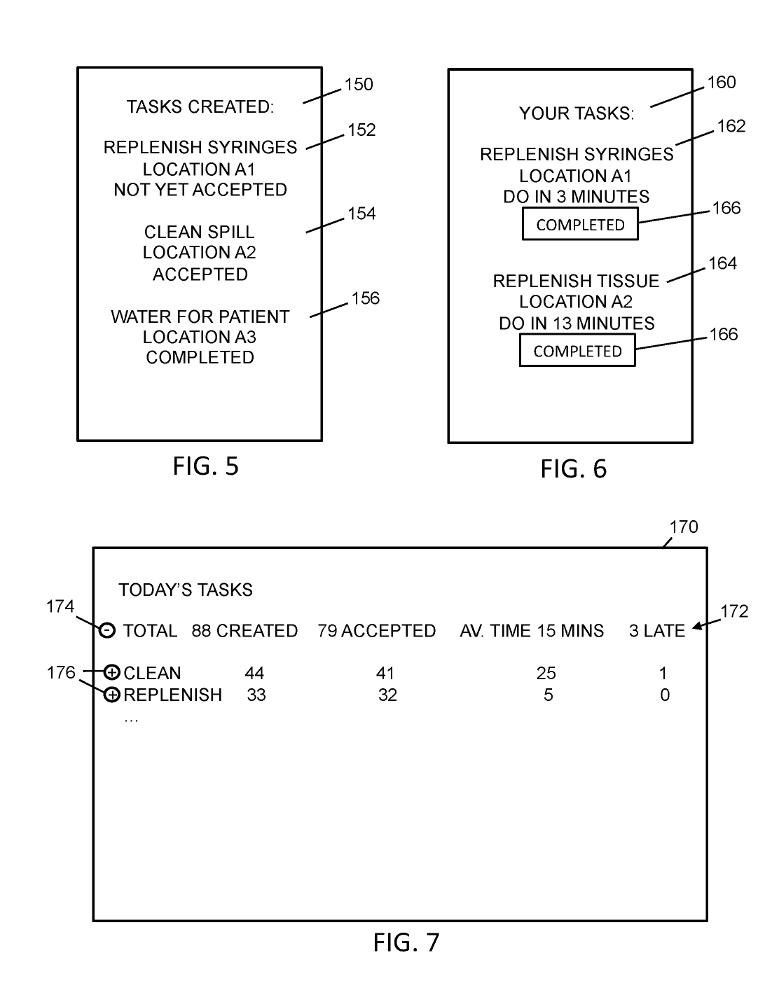

Referring to FIG. 6, an example screenshot of a recipient device is shown of a list of the tasks 160 that have been accepted by a particular user, each showing the amount of time the user has left to complete the tasks, thereby making them structured tasks. For example, the first task 162 (replace syringes) is to be completed in 3 minutes and the second task 164 (replace tissue) is to be completed in 13 minutes. Also displayed on the screen are Completed (Completion) buttons 166, which can be tapped by the user when the corresponding task has been completed.

The management of the hospital or other organization has a dashboard that shows summary statistics about the tasks, the performance of those tasks, and the time taken to perform the tasks. The management can also see statistics for tasks filtered by area of the hospital as well as individual team members. The management is able to set thresholds on specific tasks that will trigger notification of an supervisor. For example, if the average time taken to give patients water exceeds 10 minutes for more than an hour, then the system will notify the head nurse. Since some tasks can be tied not just to locations but also to patients, statistics can also be based on the patient population. Referring to FIG. 7, an example of a dashboard 170 is shown with a summary of the tasks for the day so far. The top line 172 shows the number of tasks created, the number accepted, the average time to complete them and the number of tasks that are late. An expand/collapse button 174 shows that the top line 172 has been expanded to reveal statistics for the cleaning tasks and the replenishment tasks. Each of these line can be expanded and collapsed using expand/collapse buttons 176. Many other filter types may be used on the data.

### C. Flowcharts

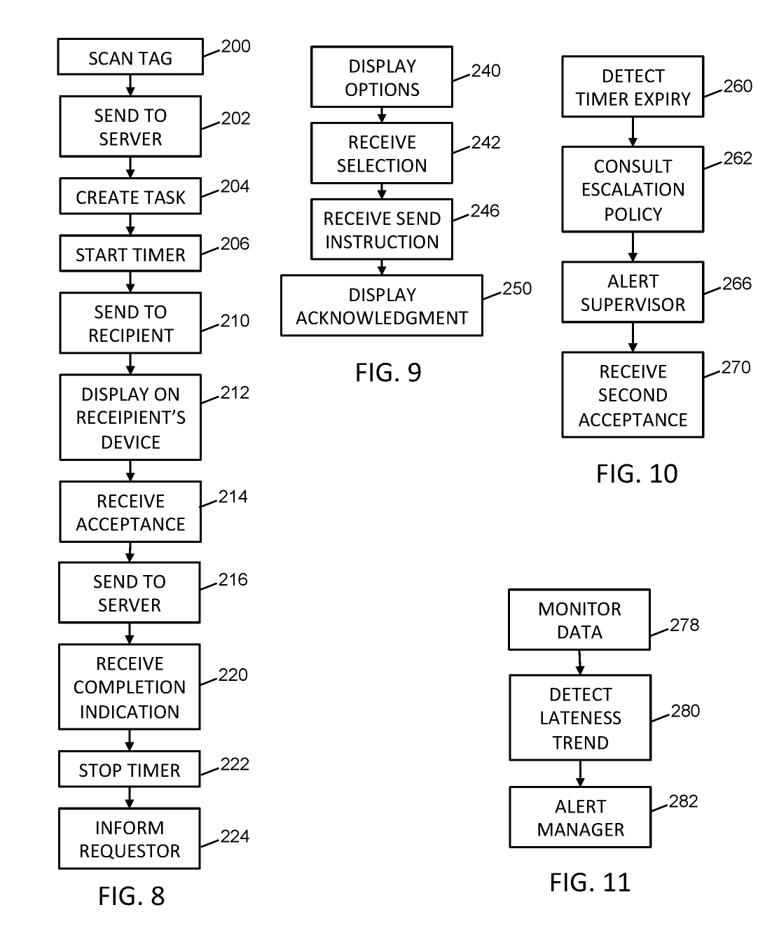

Referring to FIG. 8, a flowchart is shown of a process performed with the system 10. In step 200, a user scans a tag, such as tag 56, 62, 68 with a user device 12 having a camera 24 or other sensor. In response, the user device 12 sends a task request to the server 30 in step 202. In step 204, the server 30 creates the task that was requested, and starts a timer in step 206 for monitoring the time taken for the task to be performed. In step 210, the task is sent to a recipient, where it is displayed on the recipient's user device 40, 42, 44 in step 212. In step 214, the recipient's device receives an acceptance of the task, input by the recipient. The acceptance is transmitted to the server in step 216, which then optionally sends a notification to the user who requested the task. Following acceptance of the task, the recipient proceeds to perform the task, and after the task has been completed, the recipient's device receives, in step 220, an indication that the task has been completed, which is input by the recipient. The completion indication is then transmitted to the server. Upon the server receiving notification of completion of the task, the server stops the timer in step 222. The time taken to complete the task is then saved and used for future analytics. In step 224, the server 30 then optionally sends a notification to the user who requested the task.

Referring to FIG. 9, a flowchart is shown of a process performed with the system 10 after step 200 of scanning a tag in FIG. 8. In step 240, the user device 12 presents various options to the user in response to the user having scanned the tag. In step 242, the user device receives a selection of one of the options from the user, via the user interface on the device, such as touchscreen 22. In step 246, the user device receives a Send instruction from the user, after which the process of FIG. 8 continues with step 202. If the request is successfully sent to the server 30, the user device 250 displays an acknowledgment of the task request to the user.

FIG. 10 shows the detection of the expiration of the timer in step 260 before the task has been completed. As a result, the server 30 consults the escalation policy 130 in step 262. According to the particular escalation policy, the server 30 sends an alert to the supervisor in step 266. As a result, the supervisor arranges for the task to be completed by another member of the staff. In step 270, the system 10 receives a second acceptance of the task from the other staff member, who then proceeds to perform the task.

FIG. 11 relates to the monitoring of the performance of the tasks using the dashboard 170. In step 278, the server 30 monitors the data relating to the creation of the tasks, the acceptance of the tasks and the completion of the tasks. In step 280, the server 30 detects that for a certain group of tasks, the average time to completion is higher than a preset limit, and that it has been higher than this preset limit for a duration which is longer than another preset limit. In other words, the server detects a lateness trend. In step 282, the server 30 sends an alert to the manager to provide a notification about the lateness trend. The server 30 is therefore set to permit occasional breaches of the time limit without sending an alert to the manager, but if the breaches become persistent, then an alert is sent.

### D. Example Uses

Supply Replenishment: A nurse walks up to the supply cabinet 50 and opens the door. The nurse notices that there are no syringes remaining on the syringe shelf 54. The nurse touches her smartphone, in scanning mode, to tag 56 on the syringe shelf 54, or points the camera of her smartphone at the tag. A message with a task is automatically created, and sent to the on-call supply clerk's mobile device with a request to replenish the syringes for that particular cabinet 50. The nurse then sees that the supply clerk has accepted the task. When the supply clerk re-stocks the shelf 54, he marks the task as completed and enters the quantity of syringes added to the shelf. The nurse then gets a message immediately informing her that the syringes have been replenished. In addition, a message is sent to the hospital's inventory system to track the placement and quantity of the syringes to that location.

Bathroom Cleaning/Replenishment: A nurse walks up to a bathroom and sees that there is a spill on the floor. The nurse scans the tag on the wall of the bathroom and is presented with one of 3 options: A) Spill on Floor B) Sanitary Tissue Refill Needed C) Bathroom Unsanitary. Nurse chooses option A—Spill on Floor. The custodial staff team for that particular floor are all notified simultaneously of the spill. A first of the custodial staff accepts the task, and all other custodial staff see this, as does the nurse. The custodial staff member who accepted the task forgets to come and clean the spill. The escalation policy determines, because the task was accepted but not completed within one hour, to escalate the task to the custodial supervisor on shift, to notify him of the pending task. The custodial supervisor re-assigns the task to a second custodial team member. The spill is cleaned, and the team member that completes the task marks task as completed. The nurse and supervisor are then notified of the spill having being cleaned.

Patient Request: A nurse walks into a patient's room. The patient asks for water. The nurse scans a barcode on the patient wristband, and is presented with a menu option and chooses water. A request for water is automatically routed to the non-skilled orderly. The orderly delivers the patient with water, and marks the task as complete. The order and delivery of water is marked against the patient identifier in the database on the server.

Patient Discharge: A nurse scans a patient's badge and issues a discharge request. The discharge request is sent to the EMR system (electronic medical record). This is an example of an automated message being routed to a machine.

### E. Variations

In other embodiments, barcode tags or NFC (Near Fields Communication) tags may be used instead of the QR tags 56, 62, 66 to automate messages and tasks in a healthcare delivery environment. In these cases, the user device 12 is configured to detect the barcode or NFC tag respectively.

Tags may be placed in locations throughout a hospital other than those that have been specifically shown herein. The system 10 may be used in other settings besides healthcare.

In some embodiments, the tasks could be routed to machines for completion, such as cleaning robots, instead of being routed to human users.

While the system 10 creates tasks automatically, it may also create informative messages instead of, or as well as, the tasks. For example, if a user has accepted a task to clean a washroom and another problem is noticed in the washroom before it is cleaned, the further problem may be sent to the user by way of a message rather than a new task. If a second user notices a problem without realizing that it that has already been reported and made the subject of a task, the second user may be given a message that the task has already been created and is in hand, instead of creating a duplicate task.

In general, unless otherwise indicated, singular elements may be in the plural and vice versa with no loss of generality. The use of the masculine can refer to masculine, feminine or both.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware, firmware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

Although the present invention has been illustrated principally in relation to hospital and healthcare delivery environments, it has application in respect of other areas, such as corporate environments, government environments, city management, etc.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main functions of the system. All parameters and configurations described herein are examples only and actual values of such depend on the specific embodiment. Accordingly, the scope of the invention is to be construed in accordance with the substance defined by the appended claims.

### F. Claim Support

In some embodiments the method comprises prior to the scanning step receiving, at a server, a schema for each task that is related to the code, wherein each schema comprises: a name of the task to which the schema corresponds; an indication of an alternate recipient who is to be alerted if the server does not receive acknowledgment, within a configurable time period, that the message has been received by the recipient device; an indication of a second alternate recipient who is to be alerted if the server does not receive notification, within a second configurable time period, that the recipient device has received an acceptance of the selected task; and an indication of a third alternate recipient who is to be alerted if the server does not receive notification, within a third configurable time period, that the recipient device has received an indication of completion of the selected task.

In some embodiments the method comprises transmitting, to a server, times at which similar tasks are selected by a plurality of user devices; transmitting, to the server, times at which the similar tasks are indicated as complete; calculating, at the server, a time taken for each similar task to be completed; monitoring a running average of time taken for the similar tasks; and sending an alert to a supervisor's device if the running average exceeds a predetermined threshold. In some embodiments the alert is sent if the running average exceeds the predetermined threshold for a predetermined duration of time.

In some embodiments the method comprises displaying, on the recipient device, a duration of time in which the selected task should be completed.

In some embodiments the method comprises: displaying, on the recipient device, an acceptance button for accepting the selected task; receiving, by the recipient device, a tap on the acceptance button; and transmitting an acknowledgment of acceptance of the selected task to the user device. In some embodiments the method comprises displaying, on the recipient device, a completion button for indicating completion of the selected task; receiving, by the user device, a tap on the completion button; and transmitting an indication of completion of the selected task to the user device.

In some embodiments the recipient device is a machine that is configured to complete the selected task. In some embodiments the machine is an electronic medical record server and the selected task is to record a discharge of a patient from a hospital.

In some embodiments the recipient device is automatically selected from a server storing a schedule of personnel who are capable of completing the task; and a correlation of each of the personnel with a different one of a plurality of recipient devices.

In some embodiments the method comprises receiving, by a second user device, a second selection of the selected task; and displaying, on the second user device, an indication that the selected task has already been requested.

In some embodiments the method comprises: sending the message to a plurality of further recipient devices; displaying, on all the recipient devices, an acceptance button for accepting the selected task; receiving, by one of all the recipient devices, a tap on the acceptance button on said one recipient device; notifying the remainder of all the recipient devices that the task has been accepted; and transmitting an acknowledgment of acceptance of the selected task to the user device.

In some embodiments the method comprises displaying, on the user device, a parameter required for the selected task; and receiving, by the user device, a value of the parameter; wherein the message is sent as a structured message that includes the value of the parameter.

In some embodiments the system comprises a server configured to receive a schema for each task that is related to the code, wherein each schema comprises: a name of the task to which the schema corresponds; an indication of an alternate recipient who is to be alerted if the server does not receive acknowledgment, within a configured time period, that the message has been received by the recipient device; an indication of a second alternate recipient who is to be alerted if the server does not receive notification, within a second configured time period, that the recipient device has received an acceptance of the selected task; and an indication of a third alternate recipient who is to be alerted if the server does not receive notification, within a third configured time period, that the recipient device has received an indication of completion of the selected task.

In some embodiments the server is further configured to: receive times at which similar tasks are selected by a plurality of user devices; receive times at which the similar tasks are indicated as complete; calculate a time taken for each similar task to be completed; monitor a running average of time taken for the similar tasks; and send an alert to a supervisor's device if the running average exceeds a predetermined threshold.

1. A method of creating a task comprising the steps of:
scanning, with a user device, a tag that carries a code;
displaying, on the user device, a plurality of tasks that are related to the code;
receiving, by the user device, a selection of one of the tasks; and
sending a message to a recipient device, wherein the message notifies the recipient device of the selected task.

2. The method of claim 1, further comprising prior to the scanning step:
receiving, at a server, a schema for each task that is related to the code, wherein each schema comprises:
a name of the task to which the schema corresponds;
an indication of an alternate recipient who is to be alerted if the server does not receive acknowledgment, within a configurable time period, that the message has been received by the recipient device;
an indication of a second alternate recipient who is to be alerted if the server does not receive notification, within a second configurable time period, that the recipient device has received an acceptance of the selected task; and
an indication of a third alternate recipient who is to be alerted if the server does not receive notification, within a third configurable time period, that the recipient device has received an indication of completion of the selected task.

3. The method of claim 1, further comprising the steps of:
transmitting, to a server, times at which similar tasks are selected by a plurality of user devices;
transmitting, to the server, times at which the similar tasks are indicated as complete;
calculating, at the server, a time taken for each similar task to be completed;
monitoring a running average of time taken for the similar tasks; and
sending an alert to a supervisor's device if the running average exceeds a predetermined threshold.

4. The method of claim 3, wherein the alert is sent if the running average exceeds the predetermined threshold for a predetermined duration of time.

5. The method of claim 1, further comprising:
displaying, on the recipient device, a duration of time in which the selected task should be completed.

6. The method of claim 1, further comprising:
displaying, on the recipient device, an acceptance button for accepting the selected task;
receiving, by the recipient device, a tap on the acceptance button; and
transmitting an acknowledgment of acceptance of the selected task to the user device.

7. The method of claim 6, further comprising:
displaying, on the recipient device, a completion button for indicating completion of the selected task;
receiving, by the user device, a tap on the completion button; and
transmitting an indication of completion of the selected task to the user device.

8. The method of claim 1, wherein the code is:
a bar code;
a two-dimensional code; or
a near-field communications code.

9. The method of claim 1, wherein the recipient device is a machine that is configured to complete the selected task.

10. The method of claim 9, wherein the machine is an electronic medical record server and the selected task is to record a discharge of a patient from a hospital.

11. The method of claim 1, wherein the recipient device is automatically selected from a server storing:
a schedule of personnel who are capable of completing the task; and
a correlation of each of the personnel with a different one of a plurality of recipient devices.

12. The method of claim 1, further comprising:
receiving, by a second user device, a second selection of the selected task; and
displaying, on the second user device, a indication that the selected task has already been requested.

13. The method of claim 1, further comprising:
sending the message to a plurality of further recipient devices;
displaying, on all the recipient devices, an acceptance button for accepting the selected task;
receiving, by one of all the recipient devices, a tap on the acceptance button on said one recipient device;
notifying the remainder of all the recipient devices that the task has been accepted; and
transmitting an acknowledgment of acceptance of the selected task to the user device.

14. The method of claim 1, wherein the code is located on:
a wristband of a patient in a hospital;
an interior wall of a room in which the plurality of tasks are to be performed;
an exterior wall of a room in which the plurality of tasks are to be performed;
a door of a room in which the plurality of tasks are to be performed; or
a cupboard with respect to which the plurality of tasks are to be performed.

15. The method of claim 1, further comprising:
displaying, on the user device, a parameter required for the selected task; and
receiving, by the user device, a value of the parameter;
wherein the message is sent as a structured message that includes the value of the parameter.

16. A system for creating a task comprising
a tag with a code that relates to a plurality of tasks;
a user device; and
a recipient device;
wherein the user device is configured to:
scan the code;
display the plurality of tasks;
receive a selection of one of the tasks; and
send, to the recipient device, a message that notifies the recipient device of the selected task.

17. The system of claim 15, further comprising a server configured to:
receive a schema for each task that is related to the code, wherein each schema comprises:
a name of the task to which the schema corresponds;
an indication of an alternate recipient who is to be alerted if the server does not receive acknowledgment, within a configured time period, that the message has been received by the recipient device;
an indication of a second alternate recipient who is to be alerted if the server does not receive notification, within a second configured time period, that the recipient device has received an acceptance of the selected task; and
an indication of a third alternate recipient who is to be alerted if the server does not receive notification, within a third configured time period, that the recipient device has received an indication of completion of the selected task.

18. The system of claim 15, wherein the server is further configured to:
receive times at which similar tasks are selected by a plurality of user devices;
receive times at which the similar tasks are indicated as complete;
calculate a time taken for each similar task to be completed;
monitor a running average of time taken for the similar tasks; and
send an alert to a supervisor's device if the running average exceeds a predetermined threshold.

19. The system of claim 15, wherein:
the code is:
a bar code;
a two-dimensional code; or
a near-field communications code; and
the code is located on:
a wristband of a patient in a hospital;
an interior wall of a room in which the plurality of tasks are to be performed;
an exterior wall of a room in which the plurality of tasks are to be performed;
a door of a room in which the plurality of tasks are to be performed; or
a cupboard with respect to which the plurality of tasks are to be performed.

20. The system of claim 15, wherein the recipient device is a machine that is configured to complete the selected task.

21. Computer readable media storing computer readable instructions, which, when executed by one or more processors, cause a user device to:
scan a tag with a code that relates to a plurality of tasks;
display the plurality of tasks;
receive a selection of one of the tasks; and
send, to a recipient device, a message that notifies the recipient device of the selected task.
